(19) United States
(12) Patent Application Publication
(10) Pub. No.: US 2014/0210622 A1
(43) Pub. Date: Jul. 31, 2014

(54) PORTABLE THEFT PREVENTION DEVICE

(71) Applicant: LARRY BAILEY, WINTER PARK, FL (US)

(72) Inventor: LARRY BAILEY, WINTER PARK, FL (US)

(21) Appl. No.: 14/168,548

(22) Filed: Jan. 30, 2014

Related U.S. Application Data
(60) Provisional application No. 61/759,042, filed on Jan. 31, 2013.

(51) Int. Cl. G08B 13/14

(52) U.S. Cl. CPC G08B 13/1436
USPC 340/568.1

(57) ABSTRACT

The present invention is directed to a portable theft prevention device that includes an outer shell/main body for housing a processor that is conventionally connected to an internal memory, one or more movement detection sensors, an alarm consisting of one or both of a speaker and an alarm light, an input unit, a biometric sensor, and a power source. The device functioning to detect movement and generate an alarm in response to the detection.

### CROSS-REFERENCE TO RELATED APPLICATIONS

This application claims the benefit of U.S. Application Ser. No. 61/759,042 filed on Jan. 31, 2013, the contents of which are incorporated herein by reference.

### TECHNICAL FIELD

The present invention relates generally to alarm systems, and more particularly to a portable lightweight personal alarm device for alerting a user when movement is detected.

### BACKGROUND

The statements in this section merely provide background information related to the present disclosure and may not constitute prior art.

Each day across the country, valuable items are stolen from unsuspecting individuals. Whether the valuables are stored within lockers, gym bags, purses or briefcases, it is not uncommon for an individual to leave their belongings unattended for a short period of time and then return to find that they have been robbed. This is particularly true in locker rooms and gymnasiums, where individuals must remove their valuables such as watches, wallets, keys and cellular phones, for example, before participating in an activity. To this end, it is not uncommon for smaller gyms to provide open air cubicles and/or unattended closet areas for their members to store their belongings while exercising.

Often times, a thief will monitor what items particular individuals are storing within their bags that are being left unattended. Once the individual is no longer in sight of their belongings, the thief is able to steal the bag and/or rummage through the bag, to remove the valuables and leave the premises before the victim knows they have been robbed.

Accordingly, there is a need for a portable theft prevention device which can be physically secured to a bag or other such vessel and can function to alert a user when someone attempts to access or move their belongings.

### SUMMARY OF THE INVENTION

The present invention is directed to a portable theft prevention device. One embodiment of the present invention can include an outer shell/main body which can be physically attached to an item of value and/or a storage vessel. The device can include an internally located movement detection sensor for detecting movement of the device, and an alarm that includes one or more of a speaker and visual indicator for alerting a user to the movement. One or more input devices can function to receive user instructions to activate the functionality of the device, and a processor and memory can control the operation of the device.

Another embodiment of the present invention can include a biometric sensor which functions to validate an identity of an individual attempting to transition the device between an active monitoring state and an inactive monitoring state.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a simplistic block diagram of a portable theft prevention device that is useful for understanding the inventive concepts disclosed herein.

FIG. 2 is a front side view of the portable theft prevention device in accordance with one embodiment of the invention.

FIG. 3 is a perspective view of the portable theft prevention device in operation and in accordance with the one embodiment of the invention.

FIG. 4 is another perspective view of the portable theft prevention device in operation and in accordance with the one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

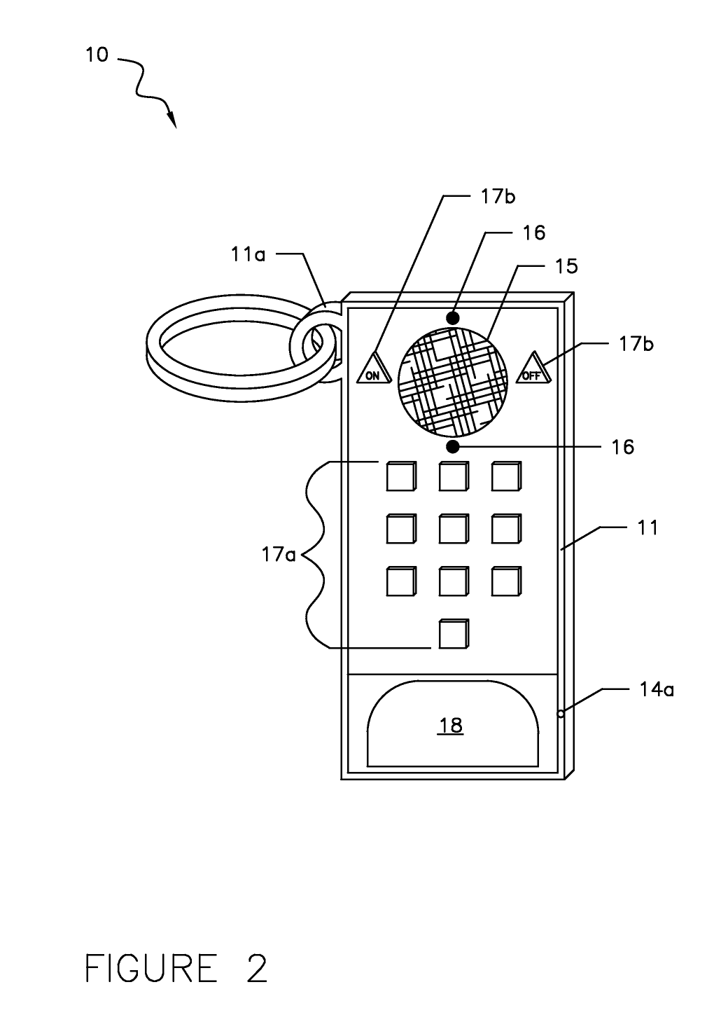

Identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 2.

Although described throughout this document with respect to particular shapes, sizes and/or intended uses, this is for illustrative purposes only, as the inventive concepts disclosed herein can be embodied in any number of different shapes, styles, sizes and designs, and can be utilized in a virtually unlimited manner. Accordingly, the below description is not to be construed as limiting upon the invention in any way.

A portable theft prevention device, as described herein, can operate as a portable alarm system which can be secured to valuables and/or placed within storage vessels wherever they are located. In operation, the device can act to automatically trigger a visual and/or audio alarm whenever the device detects movement of an item of value to which it is attached. As described herein, an “item of value” can include any physical item to which the device can be attached or otherwise communicate with. A “storage vessel” can include any item capable of receiving an item of value, such as a bag, purse, briefcase, locker, locker door, box, container and the like.

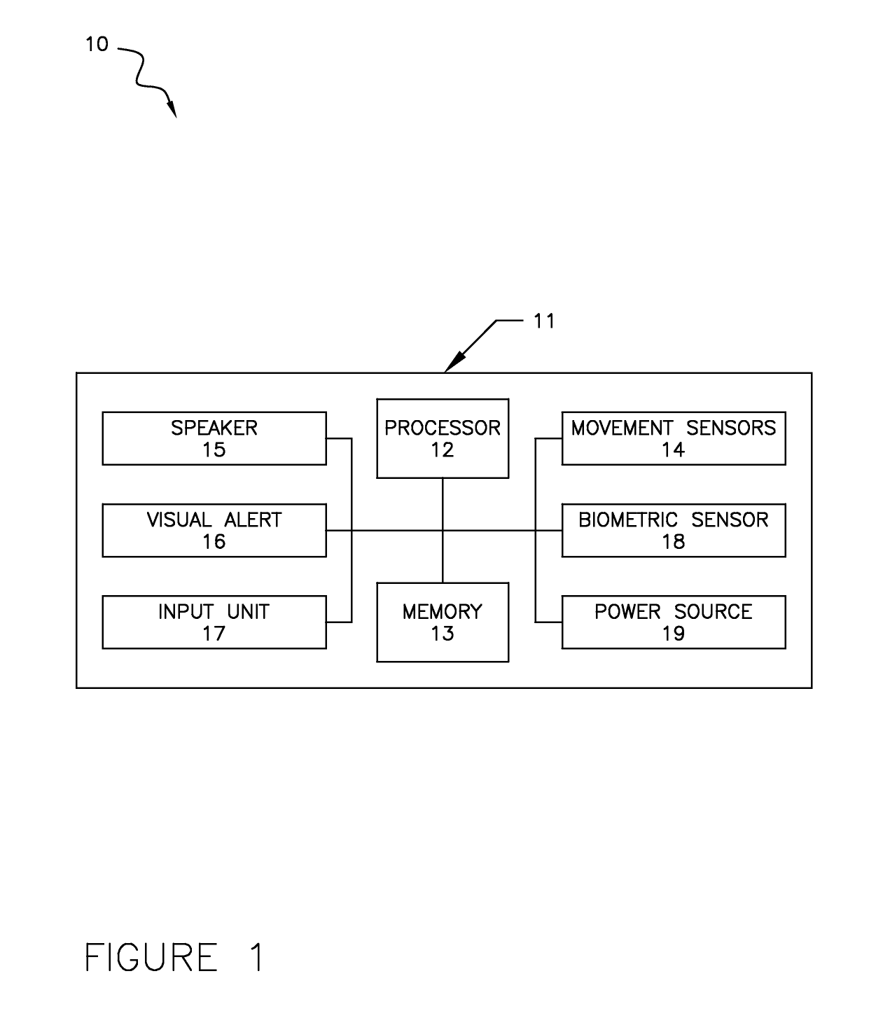

FIGS. 1 and 2 illustrate one embodiment of a portable theft prevention device that is useful for understanding the inventive concepts disclosed herein. As shown, the device 10 can include an outer shell/main body 11 for housing a processor 12 that is conventionally connected to an internal memory 13, one or more movement detection sensors 14, a speaker 15, an alarm light 16, an input unit 17, a biometric sensor 18, and a power source 19. Although the preferred embodiment of the device which includes each of the elements 11-19 is described herein, other embodiments are also contemplated. For example, the device 10 can be constructed to include or exclude any combination of elements 15-18, depending on the intended use of the device and/or manufacturing costs.

The body 11 can act to securely position any combination of the elements 12-19 of the theft prevention device 10 in a conventional manner. Additionally, the body itself can take any number of distinct shapes and sizes, and can be constructed from any number of known materials and construction methodologies. In one preferred embodiment, main body 11 can be constructed from injection molded plastic creating a waterproof outer shell and having a plurality of internal connectors (not shown) for securely positioning each of the elements 12-19. Of course, other known materials and manufacturing processes are also contemplated.

The theft protection device 10 can also include an attachment ring 11a which can be integrally formed into the body 11 in order to allow the device to be secured to an item of value via a clip, tie or other such connector. For example, the ring 11a can allow the device to be clipped to a backpack, gym bag, golf bag, purse, briefcase and other such devices that commonly carry items of value. Although illustrated as including a ring, the invention is not limited to such an arrangement., For example, any number of other attachment units 11b such as strips of hook and loop material (i.e. Velcro®), adhesion materials such as glue or resin, double sided tape, compression fittings such as snaps and buttons, and/or physical tethers, for example, among other known fasteners, can be provided in order to secure the theft prevention device 10 to any item of value and/or storage vessel in either a permanent or temporary manner.

The processor 12 can act to execute program code stored in the memory 13 in order to allow the device to perform the functionality described herein. Processors are extremely well known in the art, therefore no further description will be provided.

Memory 13 can act to store operating instructions in the form of program code for the processor 12 to execute. Although illustrated in FIG. 1 as a single component, memory 13 can include one or more physical memory devices such as, for example, local memory and/or one or more bulk storage devices. As used herein, local memory can refer to random access memory or other non-persistent memory device(s) generally used during actual execution of program code, whereas a bulk storage device can be implemented as a persistent data storage device. Additionally, memory 13 can also include one or more cache memories that provide temporary storage of at least some program code in order to reduce the number of times program code must be retrieved from the bulk storage device during execution. Each of these devices are well known in the art.

One or more movement sensors 14 can be included within the device in order to detect movement. In this regard, when the device is secured to an item of value and then activated, the movement sensor will detect when the device is being moved. Such movement can be an indication that someone is attempting to steal either the item of valuable and/or the storage vessel, or indicate that someone is in the process of rummaging through a storage vessel in which the valuable item is located. As described herein, each of the one or more movement sensors can include any number of commercially available components suitable for detecting physical motion and triggering a signal in response thereto. Several nonlimiting examples include mercury switches, non-mercury movement switches and/or and accelerometer that is implemented within the device such that when the sensor detects any movement of the device (i.e., in any plane or rotation), a signal can be generated and sent to the processor, which can then activate an alarm. In this manner, the device can include a plurality of movement sensors that are either identical to each other or different from each other.

Moreover, the movement sensor and/or processor and memory combination can also include programming wherein the device will not sound an alarm unless the movement is beyond a predetermined movement threshold. This threshold can preferably be calibrated into the accelerometer so as to prevent an alarm from sounding when the detected movement is extremely minor such as the detection of a vibration, for example.

The speaker 15 can function to generate an audible noise such as an alarm, or pre-programmed voice, for example, to audibly notify a user when the device 10 detects movement.

The device 10 can also include a visual notification such as one or more alarm lights 16. These lights, which can preferably comprise one or more LED's of varying colors and intensities, can also be activated by the processor to present a visual notification that the device has detected movement.

The device 10 can include one or more input units such as push buttons, switches or other such members. In one embodiment, a plurality of buttons can be arranged to form a keypad 17a and/or individual function buttons such as the on and off buttons 17b, for example. These buttons can function to accept user inputs and provide instructions to the processor for controlling the operation of the device. In one embodiment, one or more of the buttons can be connected to the processor 12 so as to instruct the processor to switch between an active monitoring state and an inactivate monitoring state. To this end, whenever the device is in the active monitoring state, movement that is detected by the sensor 14 will act to trigger one or more of the alarms 15 and 16. Whenever the device is in the inactive monitoring state, the device can be powered off or operate in a standby mode wherein movement of the device will not trigger an alarm.

In another embodiment, the device 10 can further include a biometric identification unit 18 that is capable of recognizing and confirming the identity of a person attempting to activate or deactivate the device 10. To this end, the biometric unit 18 can include any type of known system for confirming the identity of a user based on the users biometrics, several examples include fingerprint scanner, voice recognition, as well as a retinal and/or facial recognition system, for example. Each of these biometric systems and their functionality being well known to those of skill in the art.

To this end, the memory 13 can receive and store any necessary biometric input information from a device owner or authorized user, which can be made available to the biometric unit for comparison in order to verify the identity of any person subsequently attempting to activate or deactivate the device 10. To this end, the biometric unit can function in conjunction with the buttons described above, or can act as a single mechanism for activating and deactivating the device when the unit successfully authenticates the identity of a user.

In one preferred embodiment, the power source 19 can include one or more DC batteries capable of providing the necessary power requirements to each element of the theft prevention device 10. In one embodiment, the batteries can be integrated into the device and can be rechargeable in nature via a charging port 19a. Such a feature can prevent an unauthorized user from removing the batteries in an attempt to defeat the alarm. Of course, traditional batteries can also be utilized and the main body 11 can further include a battery compartment having a removable cover for allowing a user to access the same.

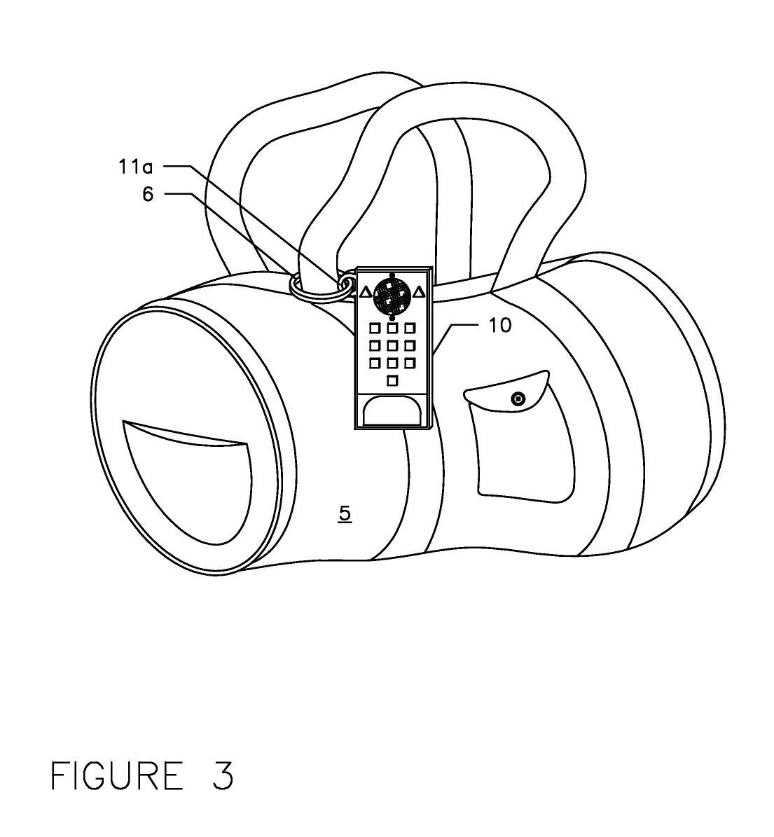

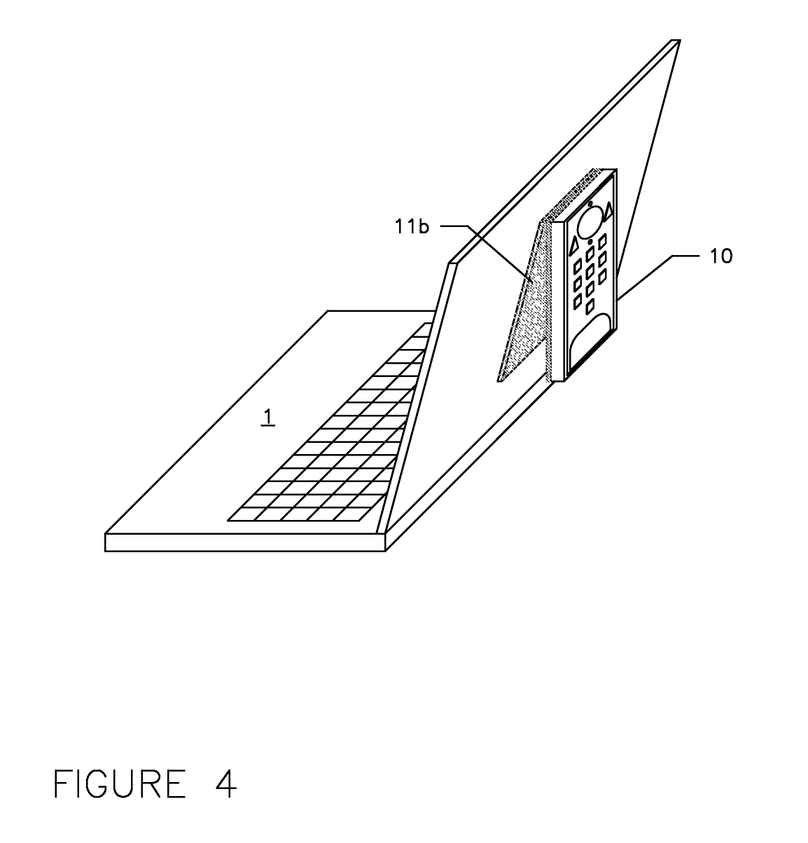

FIGS. 3 and 4 illustrate one embodiment of the theft prevention device 10 in operation. As shown in FIG. 3, the device 10 can be clipped 6 to (or alternatively placed within) a storage vessel such as the bag 5. Likewise, FIG. 4 illustrates the device 10 being physically secured directly to an item of value, in this instance a laptop computer 1, via the connector 11b.

In either instance, the device 10 can be activated by a user through operation of one or more of the keypad 17a, the on/off switch 17b or through the biometric unit 18. Once activated, the processor can trigger the light 16 to blink for a predetermined period of time (such as 15 seconds, for example) or number of times (3 blinks, for example) in order to notify the user that the device is activated. Once activated, the processor can delay operation of the sensor 14 for a predetermined period of time (such as 30 seconds, for example) in order to allow the user time to place the bag in its desired location. Once the predetermined period of time has elapsed, the movement sensor can be activated and any subsequent movement can be reported to the processor as described above.

In one embodiment, the device can include programming for delaying the alarm for another predetermined period of time (such as 10 seconds, for example) upon detection of movement by the sensor. Such a feature can allow the authorized user(s) the time necessary to access the buttons and/or biometric unit of the device in order to deactivate the same when they are ready to retrieve their items.

Accordingly, the portable theft prevention device, as described herein, presents a novel system and method for protecting valuable belongings in any setting, while ensuring only the rightful owner can move or access the same.

As described herein, one or more elements of the device 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, those of skill in the art will recognize that any means for creating and/or controlling the operation of the device can be provided herein. To this end, the device can be manufactured in accordance with any number of known construction methodologies, and one or more of the internal components, although listed as separate elements, can be formed together to form a printed circuit board or other such component, for example, in accordance with known manufacturing processes.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A portable theft prevention device, comprising:
an input unit for receiving user information;
at least one movement sensor for detecting movement of the device;
an alarm for broadcasting at least one of an audible and visual signal;
a memory configured to store operating instructions and the user information;
a processor that is in communication with and functions to control each of the input unit, the at least one movement sensor, the speaker and the memory; and
a main body for securely positioning each of the input unit, the at least one movement sensor, the speaker, the memory and the processor,
wherein the user information includes an instruction for the processor to transition the device between an active monitoring state and an inactive monitoring state.

2. The device of claim 1, wherein the memory includes instructions for ordering the processor to activate the alarm upon the movement sensor detecting a movement of the device, when the device is in the active monitoring state.

3. The device of claim 1, wherein the memory includes instructions for ordering the processor to delay activation of the motion sensor for a predetermined period of time upon receiving the user information to transition the device to the active monitoring state.

4. The device of claim 1, wherein the memory includes instructions for ordering the processor to delay activation of the alarm for a predetermined period of time upon receiving the notification of movement by the motion sensor when the device is in the active monitoring state.

5. The device of claim 1, wherein the device is configured to activate the alarm upon detection of movement that is beyond a predetermined movement threshold.

6. The device of claim 1, wherein the alarm includes at least one of a speaker and an alarm light.

7. The device of claim 1, wherein the alarm includes each of a speaker and an alarm light.

8. The device of claim 1, wherein one of the at least one movement sensors includes an accelerometer.

9. The device of claim 1, wherein one of the at least one movement sensors includes a non-mercury switch.

10. The device of claim 1, wherein the input unit includes at least one of a push button, and a switch.

11. The device of claim 1, wherein the input unit includes a plurality of push buttons arranged to form a keypad.

12. The device of claim 1, further comprising an attachment unit for securing the device to a foreign object in a permanent manner.

13. The device of claim 1, further comprising an attachment unit for securing the device to a foreign object in a temporary manner.

14. A portable theft prevention device, comprising:
an input unit for receiving user information;
at least one movement sensor for detecting movement of the device;
an alarm for broadcasting at least one of an audible and visual signal;
a biometric sensor functioning to confirm an identity of an authorized user;
a memory configured to store operating instructions and the user information;
a processor that is in communication with and functions to control each of the input unit, the at least one movement sensor, the speaker and the memory; and
a main body for securely positioning each of the input unit, the at least one movement sensor, the speaker, the memory and the processor,
wherein the user information includes an instruction for the processor to transition the device between an active monitoring state and an inactive monitoring state.

15. The device of claim 14, wherein the user information further includes biometric information pertaining to the authorized user.

16. The device of claim 14, wherein the biometric sensor includes at least one of a fingerprint scanner, a voice recognition system, a retinal scanner and a facial recognition system.

17. The device of claim 14, wherein the biometric sensor functions to transition the device between the active monitoring state and the inactive monitoring state.
